(19) United States
(12) Patent Application Publication
(10) Pub. No.: US 2003/0173775 A1
(43) Pub. Date: Sep. 18, 2003

(54) Sand tank discharge elbow

(75) Inventors: Craig F. Brennecke, Hollidaysburg, PA (US); David S. Weddle, Curwensville, PA (US)

Correspondence Address: William H. Logsdon, 700 Koppers Building, 436 Seventh Avenue, Pittsburgh, PA, 15219-1818, US

(73) Assignee: McLanahan Corporation

(21) Appl. No.: 10/388,867

(22) Filed: Mar. 14, 2003

Related U.S. Application Data
(60) Provisional application No. 60/365,377, filed on Mar. 15, 2002.

(51) Int. Cl. F16L 43/00

(52) U.S. Cl. 285/179; 285/305

(57) ABSTRACT

An apparatus and method to attach a sand tank discharge elbow to a valve in a sand classification tank using a removable spline and an optional hose clamp.

### CROSS-REFERENCE TO RELATED APPLICATION

This application claims the benefit of U.S. Provisional Patent Application Serial No. 60/365,377, filed Mar. 15, 2002, entitled “Sand Tank Discharge Elbow”, herein incorporated by reference in its entirety.

### BACKGROUND OF THE INVENTION

1. Field of the Invention

The present invention generally relates to pipe joints and couplings and, more particularly, to a discharge elbow for use with a sand classifying tank.

2. Brief Description of the Prior Art

A sand classifying tank is a piece of equipment which receives a sand and water slurry. As particles of sand flow through the sand classifying tank, coarse sand particles settle to a bottom portion of the tank, followed by finer sand particles. By combining sand particles from different sections at the bottom portion of the tank, it is possible to make different classifications of sand.

Sand particles exit a bottom portion of the sand classifying tank through a valve which meters the amount of exiting sand particles. The sand continues through a pipe attached to the valve and exits through a discharge elbow fluidly attached to the pipe.

Known discharge elbows are attached to the pipe by a bolted flange connection or a clamp assembly. When sand abrasion causes the discharge elbow to wear, the bolted flange connection or clamp assembly must be removed. Rust and corrosion makes the process of removing the bolted flange connection or clamp assembly more difficult. The process is further hampered because it is difficult to rotate the discharge elbow with respect to the pipe with the rusted and corroded bolted flange or clamp assembly partially fused to the discharge elbow.

Therefore, a need exists for an apparatus and method for easily installing and removing a sand classification tank discharge elbow.

### SUMMARY OF THE INVENTION

The present invention provides a fast and easy method of connecting one body to another body via a flexible spline. More particularly, the present invention provides a quick way of removing a discharge elbow from a pipe in a sand classifying tank without having to cut a rusted or corroded bolted flange.

A discharge elbow according to one embodiment of the present invention generally includes a hollow body which has a first end, a second end, and defines an interior surface and an exterior surface. The interior surface defines a pipe receiving recess positioned adjacent to the first end of the hollow body, an annular spline receiving recess having a first width positioned in the pipe receiving recess, and a fluid conduit portion extending between the pipe receiving recess and the second end of the hollow body. The exterior surface defines a spline receiving orifice in fluid connection with the annular flange receiving recess defined by the interior surface of the hollow body. Stiffening fins may be added to the exterior surface of the hollow body. The hollow body may generally form a curved shape, and the hollow body may be formed from an injected molded polymer.

The first embodiment discharge elbow may be added to a sand classifying tank having a bottom portion defining a plurality of orifices which receive a corresponding valve, a pipe having a first pipe end and a second pipe end connected to the valve via the first pipe end. More specifically, the discharge elbow is preferably connected to the second pipe end of the pipe, wherein the second pipe end preferably defines an annular pipe recess having a second width approximately equal to the first width of the annular flange receiving recess defined by the interior surface of the hollow body of the discharge elbow.

One method of installing the first embodiment discharge elbow onto a pipe having a first pipe end and a second pipe end, wherein the second pipe end defines an annular pipe recess having a second width approximately equal to the first width of the annular flange receiving recess defined by the interior surface of the hollow body of the discharge elbow, may include the steps of (a) positioning the second pipe end of the pipe in the pipe receiving recess defined by the second end of the pipe, (b) aligning the annular spline receiving recess with the annular pipe recess, (c) inserting a flexible spline into the spline receiving orifice, and (d) feeding the flexible spline through the aligned combination of the annular spline receiving recess and the annular pipe recess to mate the pipe and the discharge elbow together.

These and other advantages of the present invention will be clarified in the description of the preferred embodiment taken together with the attached drawings in which like reference numerals represent like elements throughout.

### BRIEF DESCRIPTION OF THE DRAWINGS

FIG. 1 is a front view of a discharge elbow according to a first embodiment of the present invention;

FIG. 2 is a side view of the discharge elbow shown in FIG. 1;

FIG. 3 is a side view of a sand classifying tank; and

FIG. 4 is an exploded view of a bottom portion of the sand classifying tank shown in FIG. 3, a pipe, and the discharge elbow shown in FIGS. 1 and 2.

### DETAILED DESCRIPTION OF THE PREFERRED EMBODIMENT

The present invention generally contemplates using a discharge elbow in a sand classifying tank. However, the invention is not limited to this specific application.

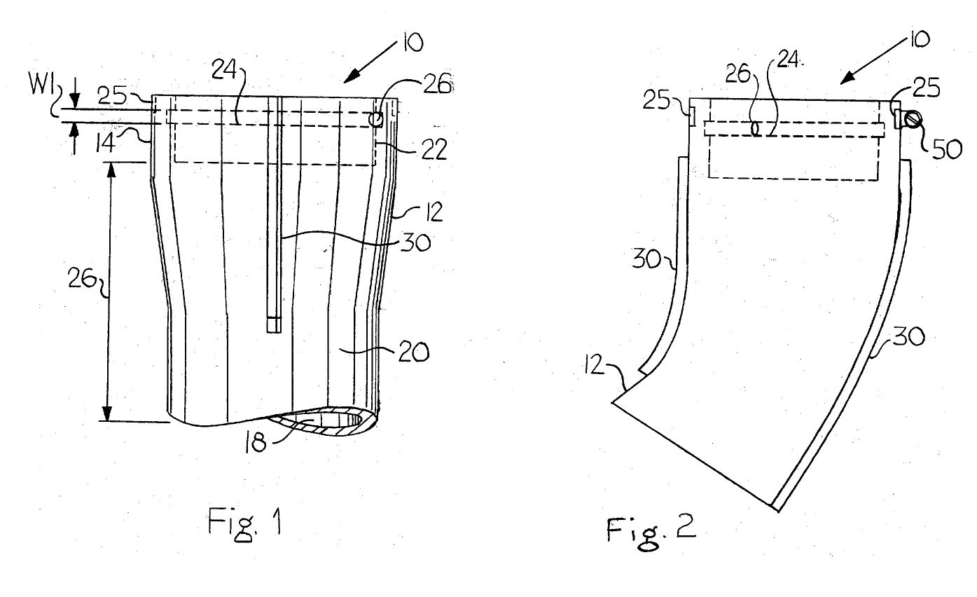

A discharge elbow 10 according to a first embodiment of the present invention includes a hollow body 12 which has a first end 14, a second end 16, and defines an interior surface 18 and an exterior surface 20. The interior surface 18 defines a pipe receiving recess 22 positioned adjacent to the first end 14 of the hollow body 12, an annular spline receiving recess 24 having a first width W1 positioned in the pipe receiving recess 22, and a fluid conduit portion 26 extending between the pipe receiving recess 22 and the second end 16 of the hollow body 12. The exterior surface 20 defines a spline receiving orifice 26 in fluid connection with the annular spline receiving recess 24 defined by the interior surface 18 of the hollow body 12. One or more stiffening fins 30 may also be added to the exterior surface 20 of the hollow body 12 to provide strength to the hollow body 12. A recess 25 can be included at the first end 14 to receive a standard hose clamp 50 (FIG. 2).

As shown in FIG. 2, the hollow body 12 and the stiffening fins 30 generally form a curved shape. Moreover, the hollow body 12 and stiffening fins 30 are preferably made from injected molded polymer or other suitable material.

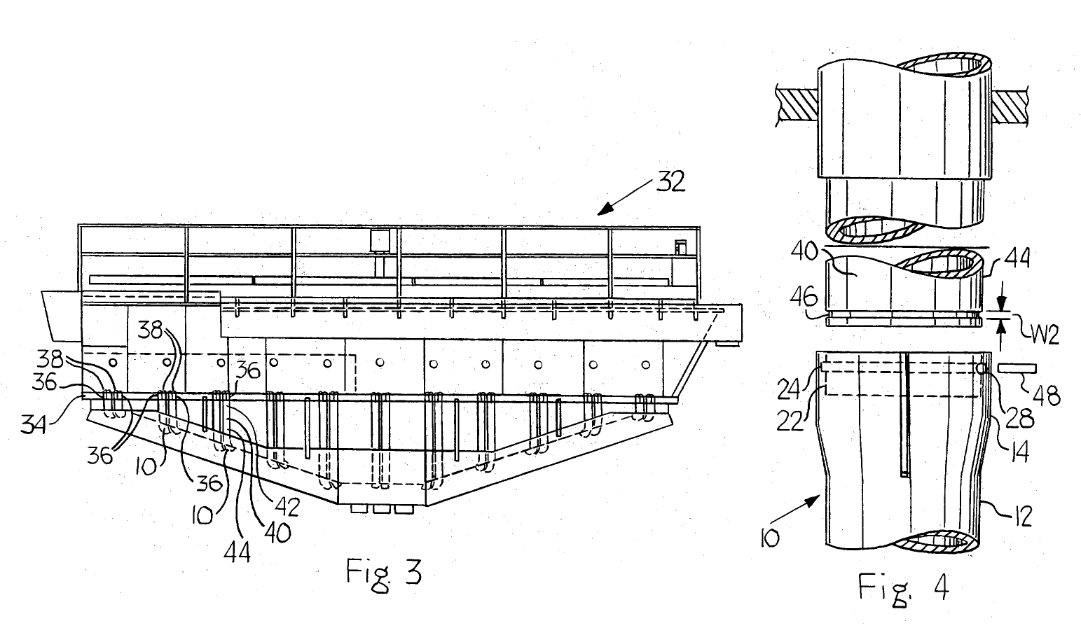

FIG. 3 generally shows a sand classifying tank 32. The sand classifying tank 32 generally has a bottom portion 34 defining a plurality of orifices 36 which each receive a corresponding metering valve 38. A pipe 40 having a first pipe end 42 and a second pipe end 44 is connected to the metering valve 38 via the first pipe end 42. The discharge elbow 10 is attached to the second pipe end 44 of the pipe 40.

As shown in FIG. 4, the second pipe end 44 defines an annular pipe recess 46 having a second width W2 approximately equal to the first width W1 of the annular flange receiving recess 24 defined by the interior surface 18 of the hollow body 12.

With continuing reference to FIG. 4, one method of installing the discharge elbow 10 includes positioning the second pipe end 44 of the pipe 40 in the pipe receiving recess 22 defined by the first end 14 of the hollow body 12. The next step is aligning the annular spline receiving recess 24 defined by the interior surface of the hollow body 12 with the annular pipe recess 46. Next, a flexible spline 48 is inserted into the spline receiving orifice 28 defined by the hollow body 12 and fed through the aligned combination of the annular spline receiving recess 24 and the annular pipe recess 46. With the flexible spline 48 properly installed, the pipe 40 and the discharge elbow 10 are mated together and the standard hose clamp 50 can be clamped around the first end 14 of the hollow body, preferably using recess 25. Removal of the discharge elbow 10 is easily accomplished by removing the optional hose clamp 50 and removing the flexible spline 48 from the aligned annular spline receiving recess 24 and the annular pipe recess 46 via the spline receiving orifice 28.

In summation, the present invention allows quick and convenient replacement of a discharge elbow. The flexible spline can be easily inserted or removed without a need for cutting rusted or corroded parts.

The invention has been described with reference to the preferred embodiment. Obvious modifications and alterations will occur to others upon reading and understanding the preceding detailed description. It is intended that the invention be construed as including all such modifications and alterations insofar as they come within the scope of the appended claims or the equivalents thereof.

We claim:

1. A discharge elbow comprising:
a hollow body which has a first end, a second end, and defines an interior surface and an exterior surface,
wherein the interior surface defines a pipe receiving recess positioned adjacent to the first end of the hollow body, an annular spline receiving recess having a first width positioned in the pipe receiving recess, and a fluid conduit portion extending between the pipe receiving recess and the second end of the hollow body; and
the exterior surface defines a spline receiving orifice in fluid connection with the annular flange receiving recess defined by the interior surface of the hollow body.

2. The discharge elbow as claimed in claim 1, further comprising a stiffening fin added to the exterior surface of the hollow body.

3. The discharge elbow as claimed in claim 1, wherein the hollow body generally forms a curved shape.

4. The discharge elbow as claimed in claim 1, wherein the hollow body is formed from an injected molded polymer.

5. A sand classifying tank comprising:
a bottom portion defining a plurality of orifices which receive a corresponding valve;
a pipe having a first pipe end and a second pipe end connected to the valve via the first pipe end; and
a discharge elbow connected to the second pipe end of the pipe, the discharge elbow comprising:
a hollow body which has a first end, a second end, and defines an interior surface and an exterior surface,
wherein the interior surface defines a pipe receiving recess positioned adjacent to the first end of the hollow body, an annular spline receiving recess having a first width positioned in the pipe receiving recess, and a fluid conduit portion extending between the pipe receiving recess and the second end of the hollow body; and
the exterior surface defines a spline receiving orifice in fluid connection with the annular flange receiving recess defined by the interior surface of the hollow body.

6. The sand classifying tank as claimed in claim 5, wherein the second pipe end defines an annular pipe recess having a second width approximately equal to the first width of the annular flange receiving recess defined by the interior surface of the hollow body of the discharge elbow.

7. A method of installing the discharge elbow onto a pipe having a first pipe end and a second pipe end, the discharge elbow comprising a hollow body which has a first end, a second end, and defines an interior surface and an exterior surface,
wherein the interior surface defines a pipe receiving recess positioned adjacent to the first end of the hollow body, an annular spline receiving recess having a first width positioned in the pipe receiving recess, and a fluid conduit portion extending between the pipe receiving recess and the second end of the hollow body;
the exterior surface defines a spline receiving orifice in fluid connection with the annular flange receiving recess defined by the interior surface of the hollow body; and
the second pipe end defines an annular pipe recess having a second width approximately equal to the first width of the annular flange receiving recess defined by the interior surface of the hollow body of the discharge elbow, comprising the steps of:
(a) positioning the second pipe end of the pipe in the pipe receiving recess defined by the second end of the pipe;
(b) aligning the annular spline receiving recess with the annular pipe recess;
(c) inserting a flexible spline into the spline receiving orifice; and
(d) feeding the flexible spline through the aligned combination of the annular spline receiving recess and the annular pipe recess to mate the pipe and the discharge elbow together.
